(19) United States
(12) Patent Application Publication
(10) Pub. No.: US 2016/0205898 A1
(43) Pub. Date: Jul. 21, 2016

(54) CONNECTED COLLAR SYSTEM

(71) Applicant: Patrick Howard Perrine, San Francisco, CA (US)

(72) Inventor: Patrick Howard Perrine, San Francisco, CA (US)

(21) Appl. No.: 15/000,977

(22) Filed: Jan. 19, 2016

Related U.S. Application Data
(60) Provisional application No. 62/105,122, filed on Jan. 19, 2015.

(51) Int. Cl. A01K 27/00; A01K 11/00; H04W 4/02; A01K 29/00

(52) U.S. Cl. CPC A01K 27/001; A01K 29/005; A01K 11/008; H04W 4/025

(57) ABSTRACT

A connected collar provides integrated electronic devices with features for controlling pet behavior and monitoring pet health. Information related to the pet may be accessed wirelessly and transmitted to the owner. The owner may remotely control, monitor, train, engage with and/or locate the pet using feedback from the collar.

### CROSS-REFERENCE TO RELATED APPLICATIONS

This application claims benefit under 35 U.S.C. §119(e) of U.S. Provisional Application having Ser. No. 62/105,122 filed Jan. 19, 2015, which is hereby incorporated by reference herein in its entirety.

### BACKGROUND

The embodiments herein relate generally to pet accessories and more particularly, to a connected smart collar system.

Animals, and in particular pets require a lot of attention and maintenance to domesticate and maintain healthy. Despite owners best intentions, the time and effort required to train and care for animals is often more than the owner has available. For example, dogs are one of the most popular pets in the U.S. Dogs need both time for training as well as attention to keep happy and from resorting to destructive tendencies with their energy. Yet 69% of owners feel their dog is important to their own health, but 1 in 8 dogs are lost in the US every year. 75% of owners feel guilty leaving their pet alone, yet 82% of dogs are alone up to 10 hours daily because the owner(s) has to go to work and has other responsibilities. 52% of dogs are overweight, but only 7% of owners are aware of the condition. Thousands of pets, for example dogs, die each year from poor health. Some causes of death are related to overheating or from the lack of exercise. Additionally, many pets are lost annually resulting in overcrowded kennels resulting in unnecessary euthanasia. Currently, pet owners lack the means to monitor their pet's health, behavior and location in real time. The marketplace for pet control and monitoring is typically limited to single function devices. Some current devices are connected to the pet as an accessory to a collar. In order to control and monitor the pet, multiple devices need to be attached as separate accessories to the pet.

As can be seen, there is a need for a system that provides control and monitoring of a pet's health from a singular device.

### SUMMARY

In one aspect, a wirelessly connected collar for providing control of a pet and monitoring of the pet's health comprises a collar body; a circuit board array in the collar body; a wireless transceiver coupled to the circuit board array; a microcontroller coupled to the wireless transceiver, the microcontroller including memory and instructions configured to receive/transmit signals by/from the wireless transceiver and control operation of one or more electronic components integrated into the collar body; and a power source powering the circuit board array, the wireless transceiver, the microcontroller, and the one or more electronic components integrated into the collar body.

In another aspect, a system for controlling a pet and monitoring the pet's health comprises a collar body; a circuit board array in the collar body; a wireless transceiver coupled to the circuit board array; a microcontroller coupled to the wireless transceiver, the microcontroller including memory and instructions configured to receive/transmit signals by/from the wireless transceiver and control operation of one or more electronic components integrated into the collar body; a power source powering the circuit board array, the wireless transceiver, the microcontroller, and the one or more electronic components integrated into the collar body; and a computer program product for providing functions related to training the pet and health monitoring, the computer program product comprises a non-transitory computer readable storage medium having computer readable program code embodied therewith. The computer readable program code is configured to: receive wireless signals from the wireless transceiver, the wireless signals associated with output from the one or more electronic components integrated into the collar body, provide an interface to a user, the interface including one or more modules to: train the pet's behavior and monitor the pet's health, access the one or more electronic components integrated into the collar body, and activate the one or more electronic components integrated into the collar body to train the pet or monitor the pet's health

### BRIEF DESCRIPTION OF THE FIGURES

The detailed description of some embodiments of the invention is made below with reference to the accompanying figures, wherein like numerals represent corresponding parts of the figures.

FIG. 1 is a front, right side perspective view of a smart collar according to an embodiment of the invention.

FIG. 2 is a front, left side perspective view of a smart collar according to an embodiment of the invention.

FIG. 3 is an exploded view of FIG. 1.

FIG. 4 is a cross-sectional top view taken along the line 4-4 of FIG. 1.

FIG. 5 is a cross-sectional view taken along the line 5-5 of FIG. 4.

FIG. 6 is a partial detailed sectional view illustrating opening/closure of the collar according to an embodiment of the invention.

FIG. 7 is a block diagram of a system and communication among system elements according to an embodiment of the invention.

FIGS. 8-9 show an electrical schematic of an exemplary circuit according to an embodiment of the invention.

### DETAILED DESCRIPTION OF CERTAIN EMBODIMENTS

Broadly, embodiments of the disclosed invention provide a smart collar integrating a plurality of electronic feedback sources for controlling pet behavior and monitoring the health and location of a pet. The smart collar may for example provide functionality related to training a pet, controlling movement, tracking a pet's location, and monitoring health related data. The smart collar may be beneficial for use with for example dogs, however it will be understood that other animals/pets may benefit from the aspects of the subject technology disclosed herein.

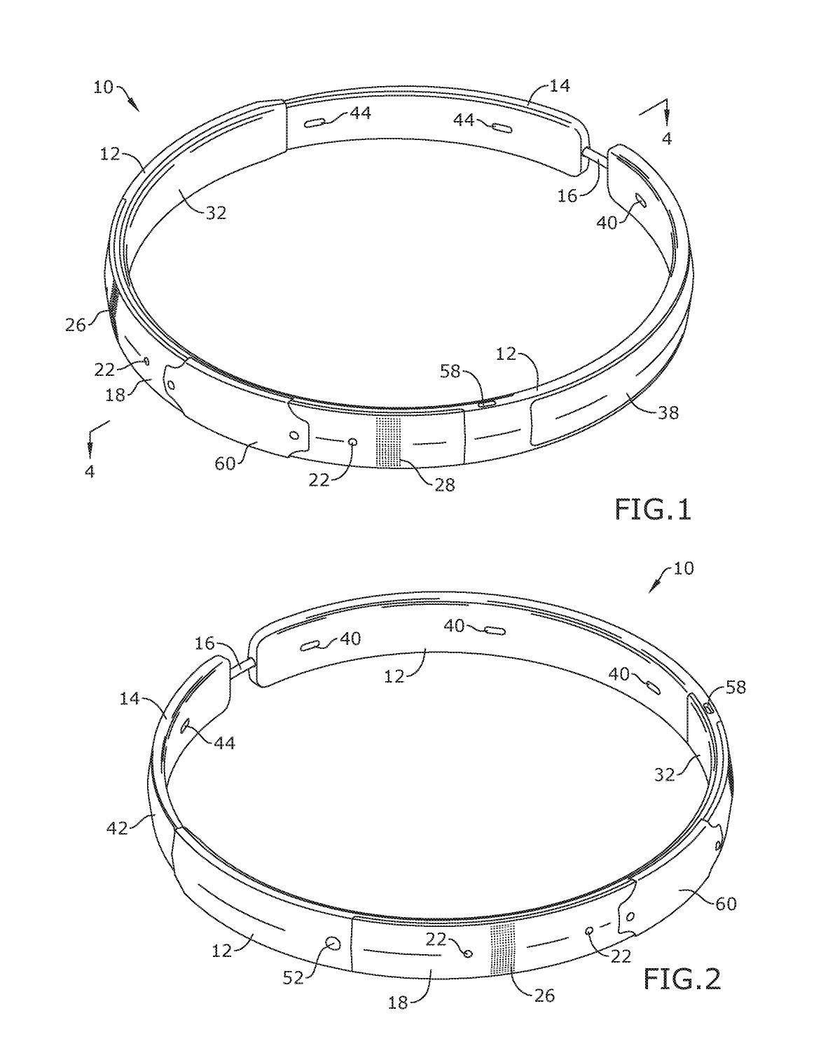

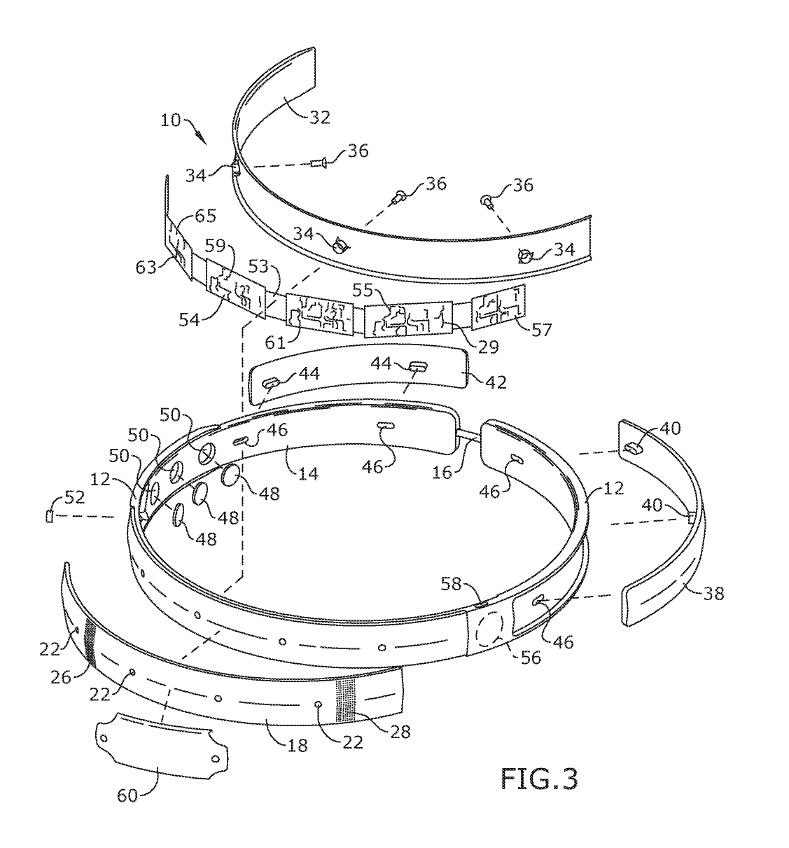

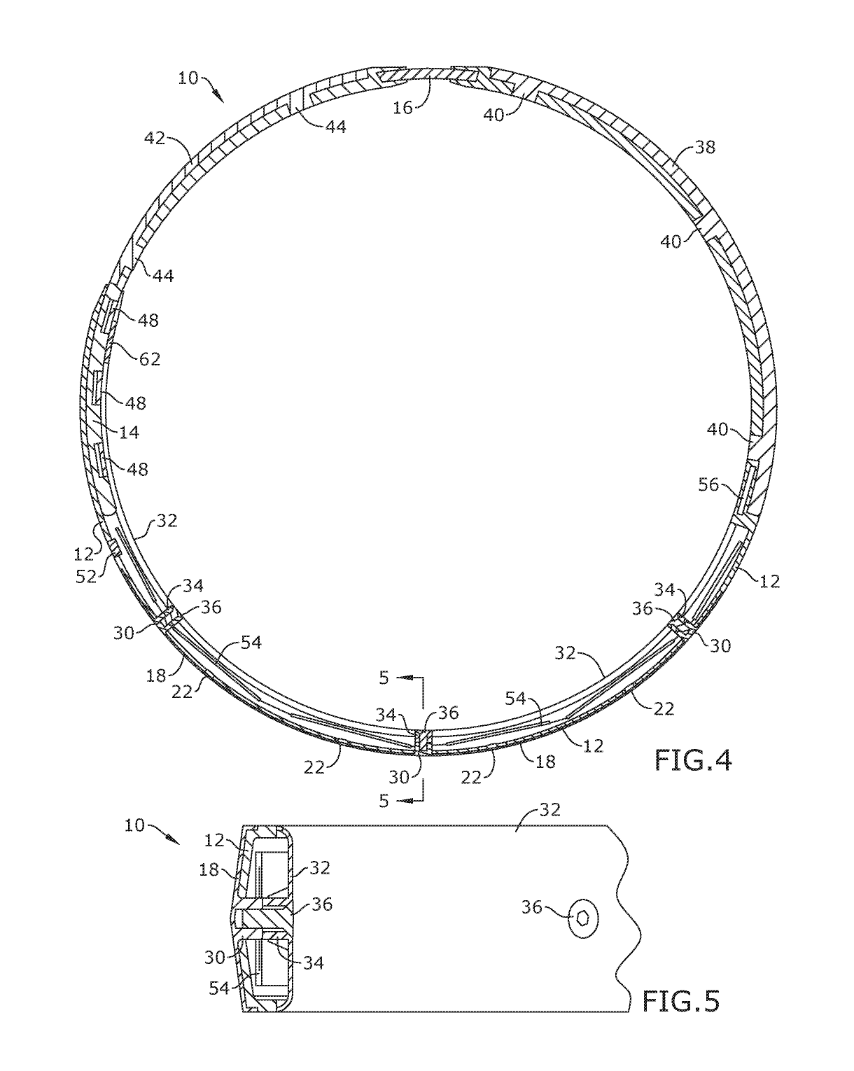

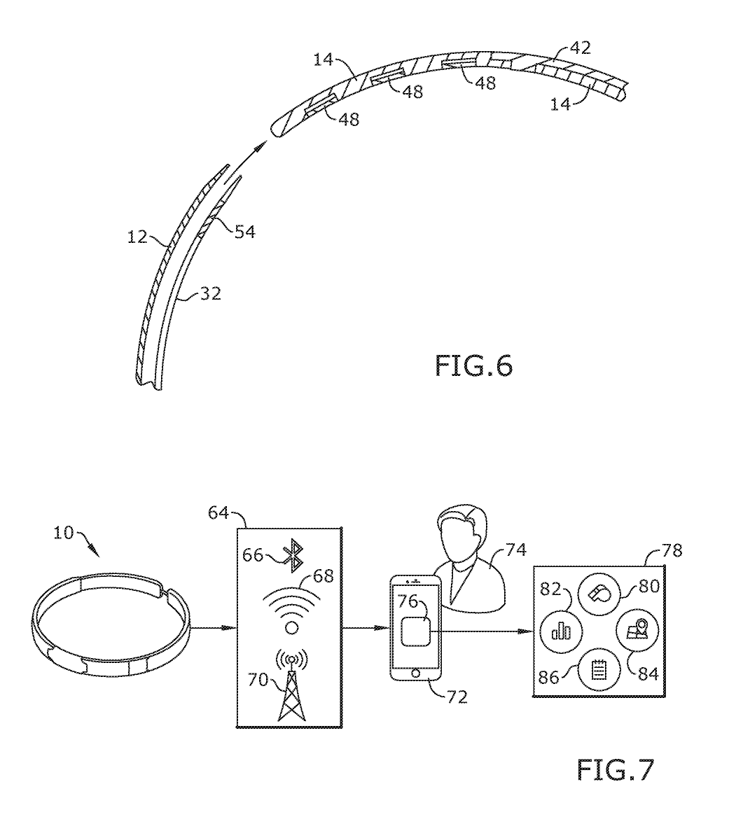

FIGS. 1-6 in general show a smart collar 10 providing multiple features for the benefit of, for example, a dog. Referring to FIGS. 1-2, the smart collar 10 includes a collar body 12 which may be for example a rigid or semi-rigid, annular body. The collar body 12 is water resistant up to for example 3 meters using anodized aluminum, titanium nickel coated, stainless steel with flexible water-resistant thermoplastic polyurethane to protect the internal components. An interior of the collar body 12 may be hollow to accommodate electronics as described more fully below. The collar body 12 may include a telescopic adjustment arm 14 that slides in and out of the collar body 12 to accommodate various fits for an animal's neck (See also FIG. 6). The adjustment arm 14 may be locked into place by moving one or more integrated magnets 48 (held within slots 50—FIGS. 3-4) into the receiving end of the collar body 12 (FIG. 4). In some embodiments, the rear casing 32 may be metallic to attract the magnet(s) 48. A rounded leash post 16 for receiving a leash (not shown) may connect the closed end of the adjustment arm 14 to the opposite end of the collar body 12. The leash post 16 may be configured to receive a magnetic leash clasp (not shown) for quick connect convenience.

Some embodiments may include features providing interchangeable skins providing a variety of appearances for the collar 10. Referring now to FIGS. 1-4, the collar body 12 may include a long skin 38 coupled to thereto by tabs 40 and a short skin 42 coupled to the collar body 12 by tabs 44. The tabs 40 and 44 may lock into holes 46. A front casing 18 (on an exterior facing surface of the collar 10) may be intermediate the long skin 38 and the short skin 42. Some embodiments may include a removable tag plate 60 adjacent the front casing 18 for engraved information (for example, pet name, address, etc.). The tag plate 60 may be clipped on to the top and/or bottom edges of the collar body 12. The collar body 12 may include one or more slot(s) 58 for receipt of skins (not shown) that change the appearance of the collar 10.

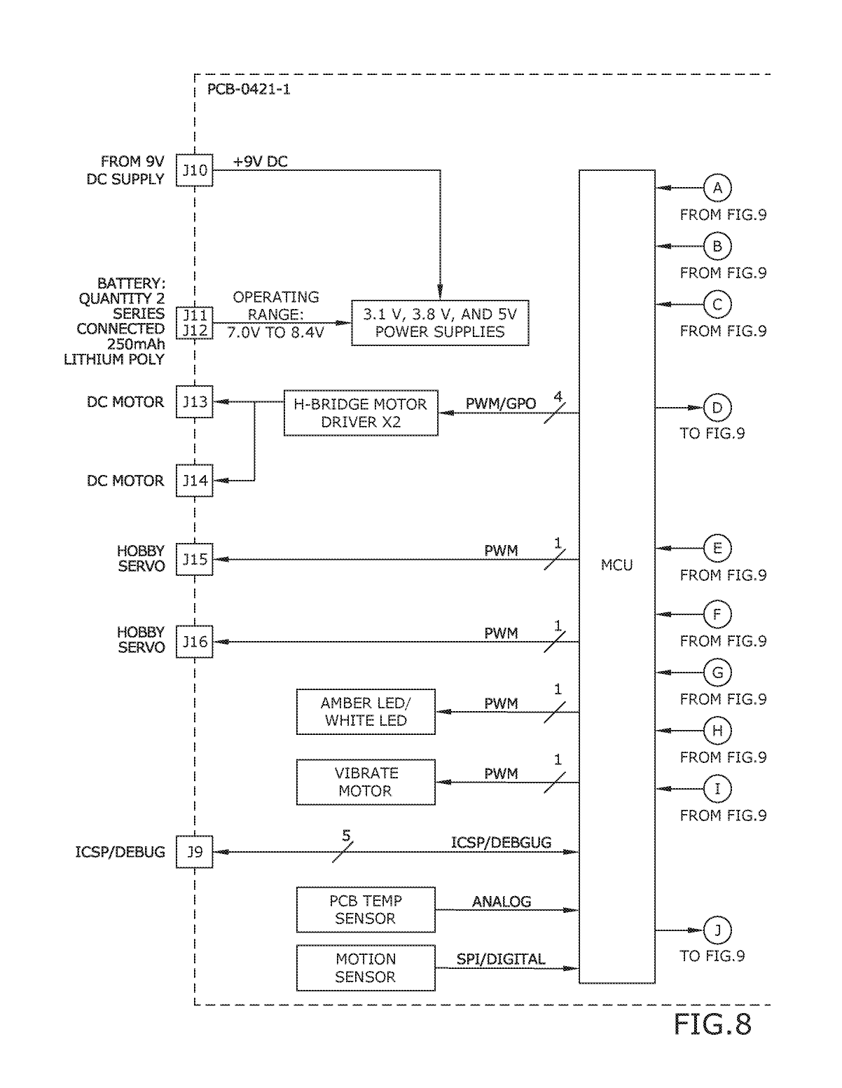

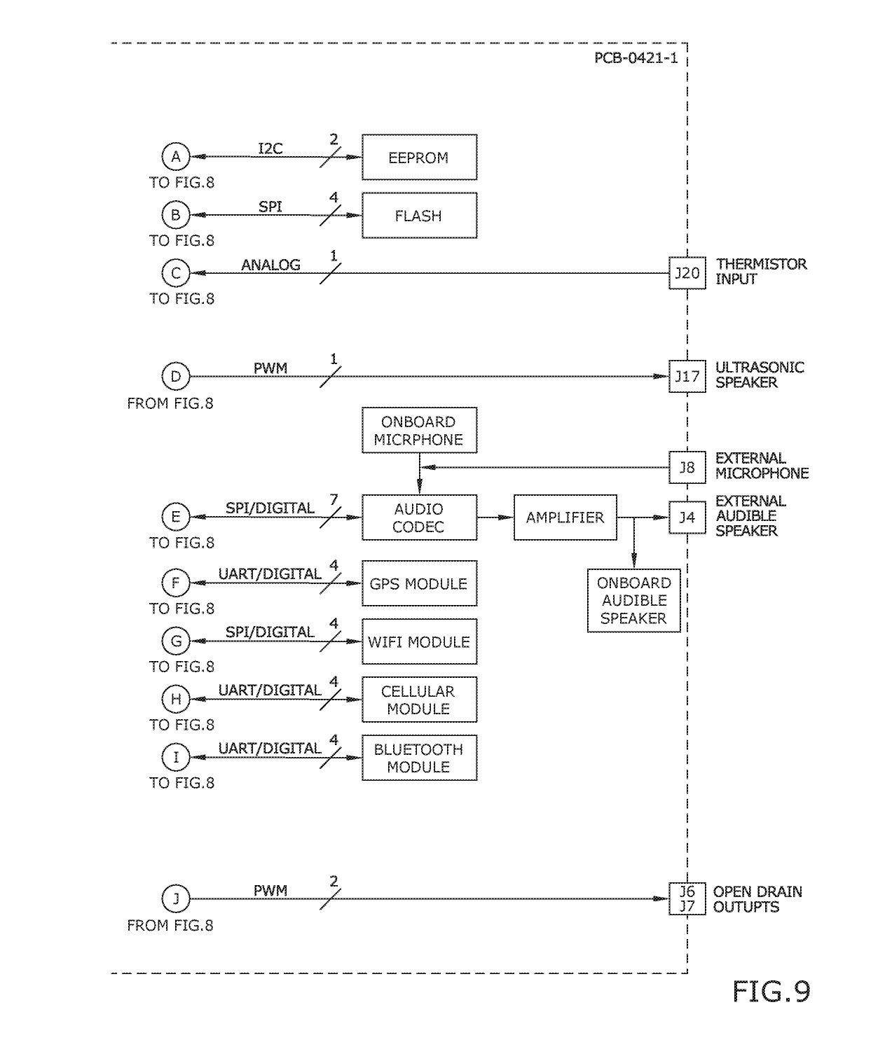

Referring now to FIGS. 1-6 and 8-9, the smart collar 10 integrates a plurality of electronic devices integrated within/between the assembly of the front casing 18, the long skin 38 and the short skin 42, and a rear casing 32. A circuit board array 54 (FIGS. 3-5) may be positioned between the front casing 18 and the rear casing 32 and locked into place by screws 36 inserted into screw holes 34 received by posts 30. The circuit board array 54 may include a microcontroller unit (MCU) or other processor with integrated firmware/software and memory storage to control the various electronic components. An exemplary circuit board array 54 connection schematic is shown in FIGS. 8-9. The circuit board array 54 may power (via battery 56—FIG. 4) and control the electronic components by direct contact with the circuit board array 54. A first speaker and grill 26 and a second speaker and grill 26 with integrated microphone 28 may be integrated into for example the front casing 18 for producing audible signals and registering sounds. Additional electronic components include for example, one or more LEDs 22 that emit from the front of the front casing 18, an ultrasonic emitter 29 for emitting ultrasonic high frequency whistles, a wireless transceiver 55, a vibration unit 59, a GPS tracking system 61, a temperature gauge 63, and a 3 axis accelerometer 65.

The various electronic devices may be connected to the power source and/or to one another if needed by a flexible bus 53. In some embodiments, the magnets 48 may be electromagnets in connection with the bus 53 and array 54 and powered to secure a strong connection providing up to 150 psi of connection strength. In some embodiments, a button 52 on the collar body 12 may be depressed to depolarize the magnetic connection for quick detachment.

Referring now to FIG. 7, in general, the electronic devices integrated into the collar 10 may be accessed remotely via the wireless transceiver 55 (FIG. 3) and controlled by a wireless computing device 72 (for example, a smart phone or tablet) using software integrated into the wireless computing device 72. The collar 10 may integrate into firmware on the circuit board array 54 for running commands delivered by a mobile app 76 and/or website via Bluetooth® 4.0 dual mode technology (classic and low energy) and/or Wi-Fi 802.11 b/g/n. protocols. The mobile app 76 may provide various training/monitoring functions 78 including for example, training functions 80, fitness/tracking functions 82, GPS tracking functions 84, and record keeping functionality 86.

System memory on either or both the wireless computing device 72 and the smart collar 10 may include at least one program product having a set of program modules that are configured to carry out the functions of embodiments of the invention. The program modules generally carry out the functions and/or methodologies of embodiments of the invention as described herein. As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented as instructions provided to the processor of the wireless mobile device and/or the MCU of the smart collar 10 to produce a machine, such that the instructions, which execute via the processor create means for implementing the functions/acts specified in the flowchart and/or block diagram block or blocks.

The functions described above and implemented by the MCU of the smart collar or processor of the wireless computing device 72 may be aided by the integrated electronic components discussed with respect to FIGS. 1-3. The ultrasonic emitter may be useful for example in preventing unwanted barking. For example, to train an animal's behavior, a user 74 may access the training function module 80. Within the training function 80, the user 74 may access and activate the ultrasonic emitter 29 to emit a high pitched sound in the range of 5800 Hz to 12,400 Hz (inaudible to humans) via microspeakers 26 that trains for example a dog to cease and desist in undesirable behavior. Using this method, dogs are safely and humanely discouraged from for example barking. The ultrasonic emitter 29 may also be used for training the pet in responding to commands. For example, pre-programmed “whistles” from the emitter 29 may be used as commands to train a dog to perform certain actions (For example, 1 short blast=sit, 2 short blasts=stay, 3 short blasts=down, 1 long blast=come.

The position of the pet may be controlled by the following features. The GPS tracking function 84 may access the GPS tracking system 61 to monitor the location of or track a lost pet. GPS signals may be forwarded to the transceiver 55 which may in turn forward to the wireless computing device 72 for display of where the pet is located. In addition, the GPS function 84 maybe used in conjunction with a virtual fence and leashing system to detect the position of the pet within a virtual boundary. The vibration unit 59 may be triggered by the pet reaching a boundary limit (the perimeter of which may be set by a user setting in the mobile app 76) setting the collar body 12 to vibrate indicating to the pet that it should move back. In some embodiments, an ultrasonic whistling sound (as described above) may be used in conjunct on to train the animal from moving past the virtual boundary. It may also be appreciated that the LEDs 22 provide the owner and for example car drivers, with easy visualization of a dog out walking on the streets at night.

The health of the pet may be monitored using the temperature gauge 63 and 3-axis accelerometer 65. Body temperature may be transmitted to the user's mobile device 72 so that rapid changes in the pet's core temperature can be monitored. In some embodiments, an alert may be triggered in response to the temperature gauge 63 reaching a predetermined temperature. The 3-axis accelerometer 65 may track steps the pet has taken, distance walked by the pet, and an activity duration and intensity over a predetermined time interval. Thus, the user 74 may evaluate whether the pet has exerted healthy exercise during the course of the day to determine whether more exercise is needed or if the user needs to ease up on the pet. For example, many owners enjoy taking a dog out for a run however; the amount of running by an older dog may need to be limited to avoid injury to joints or heat stroke.

Data transmitted by the smart collar 10 may be stored using the record keeping function 86 and/or website. For example, vaccination records may be stored and associated with the collar 10 so that access to the collar 10 brings up the pet's history. The pet's daily activities may be tracked (walks, playtime, rest/sleep) in details and snapshot views. The overall movement/activity (rest/light activity/moderate activity/high activity) may be tracked and displayed on the mobile device. Locations visited/traveled throughout day by the pet (i.e. with dog walker) may be recorded. The app/website may also include a feature to set activity goals and track progress. The GPS locator may be displayed on an easy-to-use interactive map to locate and search the pet as well as track its movements. A notifications feature (via text, email, in app) may send messages based on the pet's tracked activity. For example, if a dog crosses virtual fence boundary, its activity level changes significantly, or it is overheating or too cold. A nanny diary feature allows any pet care takers (walkers, daycare, friends/family, etc.) to upload notes, photos and or receive instructions from the owner (notes, food requirements, medication instructions/records, etc.). It will be understood that the mobile app/website 72 will allow the caretaker to login and access the pet's information by association with the collar. In addition, social networking activity including sharing auto-messaging via SMS/email/posts of events related to the pet may be performed using the mobile app/website function.

As may be appreciated, the above described features and functions in the mobile app 76 may assist the user 74 in training an animal by accessing the various functions described above with software modules for a specific type of training. In an exemplary embodiment, the aspects in which an animal is trained may be provided through a progression of behavioral control. The mobile app 76 may offer an initial phase of training which when mastered guides the user 74 through the next phase, For example, the user 74 may access a module for the training function that can assist the user 74 to teach an animal to perform a certain behavior on command. In some embodiments, the mobile app 76 may allow the user 74 to unlock additional or advanced training modules once a training module is mastered. The level of training in unlocked/advanced modules may require more functions from the collar 10 to be incorporated. As will be appreciated, by providing multiple physical outputs from the collar 10, animal training may be facilitated since the animal has more cues to respond to which reinforces behavior.

The following describes a training module teaching an animal to sit on command in phases of training. It will be understood that other behavior training modules may be included but for sake of illustration, only the progression of teaching an animal to sit is shown.

“Sit—Phase 1” the following instructions may be based on the principle of luring the animal into the desired behavior using a visual command and a physical signal from the collar 10 to reinforce behavior with effect.

“Setup: Start with minimal distractions, inside, or outside in a quiet spot on leash. Have some small, tasty treats handy in a pocket or treat pouch. Keep the DogTelligent app . . . ” (for example, the mobile app 76) “ . . . handy.”

“Lure: Start with a treat in your dominant hand, and the DogTelligent App in your non-dominant hand. Offer the treat to your dog, but don't let him eat it. Draw your hand up over your dog's head and back towards his eyes, making sure his head is following the treat. Don't bring the treat up too high or your dog will jump up for it. When your dog's bottom hits the ground, click “Action” on the DogTelligent app and then give your dog the treat!”

For Phase 1, the “Action” may be for example, initiate the collar to produce a “clicker” sound. As may be appreciated, the animal may associate the physical manifestation from the collar 10 with the act of sitting and the treat is a reward that reinforces the events as positive behavior.

For Phase 2 of training to sit, the principles of identifying the animal by name, adding a cue for the animal to recognize a command, and luring may be used. The following may be shown in the module:

“Setup: Start with minimal distractions, inside, or outside in a quiet spot on leash. Have some small, tasty treats handy in a pocket or treat pouch. Keep the DogTelligent app handy.” “Lure” (for example as described above), “Add the cue: Say the word “Sit!” Lure the behavior as you have been doing in the first step. When your dog's bottom hits the ground, click “Action” on the DogTelligent app and give your dog the treat!”

In some embodiments, the module(s) may include a tip feature that provides insight into training techniques. The tips will help the user 74 in administering efficient training techniques and will lessen the amount of time needed to train. For example: “Tips: Say each word (name & sit) only one time. If you repeat yourself, “Sit, sit, sit, sit” you risk teaching your dog not to listen to your first command. Make sure to keep the cue to a simple “Sit!” “Can you sit?” or “Will you sit?” will not be understood as the same cue. Keep your voice calm and neutral, or even happy. Intimidating your dog with a stern voice is not the goal.”

For Phase 3: “Continue to work with minimal distractions. Have some small, tasty treats handy in a pocket or treat pouch. Keep the DogTelligent app handy.

Lure: Say the word “Sit!” Your dog may sit just for the verbal cue, which is excellent! If your dog does not sit with just the verbal cue, add a hand signal. Start with your hand out, palm flat and facing up. Bring your hand up in the air to bring your dog's gaze upwards. When your dog's bottom hits the ground, click “Action” on the DogTelligent app. Grab a treat from your treat pouch or pocket and give your dog a treat!

Tips: When you start with just the verbal cue and hand signal, your hand signal might need to be more exaggerated, starting at the dog's nose. As you progress, make the hand signal smaller. Make sure not to reach for your pocket or treat bag until after you have clicked “Action” on the app. If you reach for your treat too soon, your dog will respond to that movement and not the verbal cue and hand signal.”

In Phase 4, a new cue may be added. Additional collar based cues may be unlocked by this phase providing the user 74 with additional tools. A new cue may be introduced to the animal by activating one of the features on the collar 10 which outputs a physical manifestation; for example the microspeakers 26, the ultrasonic emitter 29, or the vibration unit 59. Instructions may read as follows: “Continue to work with minimal distractions. Have some small, tasty treats handy in a pocket or treat pouch, Keep the DogTelligent app handy.

Lure: Click the “Sit” icon on the DogTelligent App. Say the word “Sit!” When your dog's bottom hits the ground, click “Action” on the DogTelligent app. Grab a treat from your treat pouch or pocket and give your dog a treat!

Tips: In this phase we are transferring the behavior to the corresponding cue from the DogTelligent Connected Collar. Start by using the new cue, and then using the old cue “Sit” and then reinforcing the behavior. Your dog may be confused at first. The new cue does not initially have any meaning for him. It will take a few repetitions for the command to transfer.”

For Phase 5, the animal may be trained with more distractions present to reinforce the commands despite other stimuli being present.

“Dog should now be fluent in both verbal “Sit” cue and the “Sit” cue from the DogTelligent Connected Collar. You may start practicing in more distracted environments. Continue to have small, tasty treats handy in a pocket or treat pouch. Keep the DogTelligent app handy.

Lure: Click the “Sit” icon on the DogTelligent App. Say the word “Sit!” When your dog's bottom hits the ground, click “Action” on the DogTelligent app. Grab a treat from your treat pouch or pocket and give your dog a treat!

Tips: In this final phase we are starting to fade the food reward. Start rewarding your dog at random intervals. See our article on variable reward for tips on fading the food reward.”

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A wirelessly connected collar for providing control of a pet and monitoring of the pet's health, comprising:
a collar body;
a circuit board array in the collar body;
a wireless transceiver coupled to the circuit board array;
a microcontroller coupled to the wireless transceiver, the microcontroller including memory and instructions configured to receive/transmit signals by/from the wireless transceiver and control operation of one or more electronic components integrated into the collar body; and
a power source powering the circuit board array, the wireless transceiver, the microcontroller, and the one or more electronic components integrated into the collar body.

2. The wirelessly connected collar of claim 1, further comprising an ultrasonic emitter connected to the microcontroller and configured to receive commands to emit ultrasonic signals for training the pet.

3. The wirelessly connected collar of claim 1, further comprising a GPS tracker system integrated into the collar body connected to the microcontroller and the wireless transceiver for providing a location of the pet.

4. The wirelessly connected collar of claim 1, further comprising a 3-axis accelerometer configured to measures steps the pet has taken, distance walked by the pet, and an activity duration and intensity over a predetermined time interval.

5. The wirelessly connected collar of claim 1, further comprising a temperature gauge configured to provide the pet's temperature for monitoring the health of the pet.

6. The wirelessly connected collar of claim 1, further comprising an adjustment arm and one or more magnets coupling the adjustment arm to the collar body.

7. A system for controlling a pet and monitoring the pet's health, comprising:
a collar body;
a circuit board array in the collar body;
a wireless transceiver coupled to the circuit board array;
a microcontroller coupled to the wireless transceiver, the microcontroller including memory and instructions configured to receive/transmit signals by/from the wireless transceiver and control operation of one or more electronic components integrated into the collar body;
a power source powering the circuit board array, the wireless transceiver, the microcontroller, and the one or more electronic components integrated into the collar body; and
a computer program product for providing functions related to training the pet and health monitoring, the computer program product comprising a non-transitory computer readable storage medium having computer readable program code embodied therewith, the computer readable program code being configured to:
receive wireless signals from the wireless transceiver, the wireless signals associated with output from the one or more electronic components integrated into the collar body,
provide an interface to a user, the interface including one or more modules to:
train the pet's behavior and monitor the pet's health,
access the one or more electronic components integrated into the collar body, and
activate the one or more electronic components integrated into the collar body to train the pet or monitor the pet's health.

8. The system of claim 7, further comprising computer readable code configured to activate an ultrasonic emitter connected to the microcontroller, the code configured to provide commands to emit ultrasonic signals for training the pet's behavior.

9. The system of claim 7, further comprising computer readable code configured to activate a GPS tracker system integrated into the collar body receive a location of the pet.

10. The system of claim 7, further comprising computer readable code configured to read data from a 3-axis accelerometer integrated into the collar body and configured to read a number of steps the pet has taken, a distance walked by the pet, and an activity duration and intensity over a predetermined time interval associated with the pet.
